(19) United States
(12) Patent Application Publication
(10) Pub. No.: US 2025/0196425 A1
(43) Pub. Date: Jun. 19, 2025

(54) EXTRUSION BLOW MOULDING MACHINE

(71) Applicant: ALPLA Werke Alwin Lehner GmbH & Co. KG, Hard (AT)

(72) Inventors: Joachim BRAUN, Kressbronn (DE); Christian PREISS, Feldkirch (AT)

(73) Assignee: ALPLA Werke Alwin Lehner GmbH & Co. KG, Hard (AT)

(21) Appl. No.: 18/848,692

(22) PCT Filed: Mar. 22, 2023
(86) PCT No.: PCT/EP2023/057370

§ 371 Date: Sep. 19, 2024

(30) Foreign Application Priority Data
Mar. 23, 2022 (CH) 000310/2022

(51) Int. Cl. B29C 49/46; B29C 49/04

(52) U.S. Cl. CPC B29C 49/46; B29C 49/04; B29C 2049/4697

(57) ABSTRACT

The invention relates to an extrusion blow molding machine (100) comprising an extruder and a blow molding tool (20). The blow molding tool (20) is separated from the environment by an enclosure (30).

The present invention relates to extrusion blow molding machine according to the preamble of the independent claims.

Various extrusion blow molding machines for the production of plastic containers are known from the prior art.

Nowadays, even highly sensitive products, such as medicines, are packaged in plastic containers. Depending upon the requirements of the products, these require certain conditions during packaging or filling. Where applicable, this also applies to the containers. In particular, it can be necessary to clean the containers before use so that only a small number of particles adhere to them, which do not exceed a predetermined limit value.

The subsequent filling of the containers and/or packaging thereof takes place in particular under clean room conditions.

In order to be able to dispense with time-consuming cleaning of the containers, it has already been proposed that entire production halls in which the extrusion blow molding machines are arranged be designed as clean rooms. This requires considerable technical effort, and in the event of a malfunction of a blow molding machine, there is a risk that entire production batches and/or neighboring production lines will be contaminated.

The object of the invention is to eliminate at least one or more disadvantages of the prior art. In particular, the aim is to create an extrusion blow molding machine that makes it possible to produce plastic containers that no longer need to be cleaned before further use and, in particular, that meet clean room standards.

This object is achieved by the device defined in the independent claims. Further embodiments result from the dependent claims.

An extrusion blow molding machine according to the invention comprises an extruder and a blow molding tool for producing a container. The blow molding tool is separated from the environment by an enclosure.

By separating the blow molding tool from the environment, an atmosphere can be created within this separation, i.e., within the enclosure, that corresponds to the desired conditions. The enclosure can accordingly reduce the influence of the environment on the blow molding tool. In particular, it is possible to prevent the entry of contaminants, in particular dirt particles, into the region in which the container is manufactured.

It can be provided that a compressor be arranged on the enclosure at a first front end for supplying the enclosure with air.

The term front or front end is understood to mean a local assignment. The front side must be distinguished from a top side and a bottom side. In particular in the case of elongated elements, i.e., elements with two long sides and two short sides such as an elongated enclosure, the front sides are those that limit the longitudinal extension, i.e., the short sides.

If the enclosure is pressurized with air, an overpressure is created within the enclosure. An overpressure can further reduce the entry of dirt particles into the enclosure. In addition, such an arrangement allows certain tolerances with regard to the tightness of the enclosure. It is not necessary for the enclosure to seal the blow molding tool airtight from the environment; rather, certain leaks or gaps are possible.

By providing an overpressure within the enclosure, in particular by supplying air, a directed air flow can be forced from within the enclosure towards the environment. Dirt particles that may arise within the enclosure during operation of the blow molding tool are carried away from the blow molding tool to the outside. This increases the quality of production in terms of a possible dirt particle count.

Additionally or alternatively, it can be provided that a compressor be arranged on the enclosure at a second end, opposite the first front end, for supplying the enclosure with air.

In addition to the advantages that have been described with regard to the compressor at the first end of the enclosure, a second compressor enables the creation of a specific air flow within the enclosure.

In addition, by providing a second compressor, the first compressor, and accordingly also the second compressor, can be designed with a reduced size.

In addition, it is possible to supply the blow molding tool with air from different sides within the enclosure, so that it is exposed to a flow from several sides, and any dirt particles that may arise are reliably removed.

It can be provided that outflow openings be arranged on the side of the enclosure so that a substantially horizontal flow is created.

In this connection, on the side is to be understood relative to the flow. If the compressors are arranged at the front, a flow in the longitudinal direction is created. On the side therefore means perpendicular to this direction.

The horizontal flow causes the dirt particles to be transported in the same direction as the containers, wherein, in the case of an arrangement of two compressors in one region, the flows collide. The horizontal flow makes it possible to provide the outlet openings centrally and laterally. This is not possible with a vertical flow.

Given the current configuration, a free space remains above the blow molding machine, which can be accessed with a crane, for example. This means that maintenance work on the blow molding machine, especially on the blow mold, can be carried out quickly and cost-effectively, since access from above is not hindered by additional equipment.

Preferably, each compressor is assigned a filter element, in particular a HEPA filter.

By providing a filter element on each compressor, air with a predefined quality can be introduced into the enclosure. This results in a corresponding quality of the atmosphere within the enclosure. This can be classified according to a quality or purity class according to ISO 14644-1, provided that the filter element has a corresponding filter performance.

The design as a HEPA filter according to EN 1822-1:2009 ensures a certain quality level of the inflowing air.

It can be provided that a conveyor belt be arranged within the enclosure to transport the blow-molded articles into a clean room. In other words, the enclosure can extend to a clean room arranged at a distance from the blow molding machine, wherein the conveyor belt is arranged within this extension of the enclosure.

Such an arrangement allows the articles produced by the blow molding machine—typically, plastic containers—to be conveyed immediately after their production under the same conditions as they exist in the enclosure. In other words, the articles remain in the same clean atmosphere until they are further processed, and contamination with dirt particles is prevented.

It can be necessary to provide a particle sensor within the enclosure to constantly monitor the conditions in the enclosure. If necessary, the performance of the compressor or compressors can be controlled based upon the current contamination level.

In the clean room, the articles can for example be filled directly or also packaged for further processing—for example, for shipping.

The region or extension of the enclosure in which the conveyor belt is arranged can, for example, be designed as an extension of the original enclosure, in which the blow molding tool is arranged.

Alternatively, it can be provided that the conveyor belt be separated from the environment by a separate enclosure—for example, with a clean air tent. This separate enclosure can also be pressurized separately.

It can be provided that the enclosure, in particular the enclosure in which the blow molding tool is arranged, be arranged within a safety fence.

The safety fence makes it possible to arrange other components of the extrusion blow molding machine in close proximity to the blow molding tool, but outside the enclosure. This allows, for example, permanent visual inspection of these components, wherein it is ensured that safety regulations and minimum distances are observed. In addition, the arrangement outside the enclosure can prevent the entry of dirt particles into the region of production of the articles—for example, containers.

In order to protect the atmosphere inside the enclosure from dirt particles, the extruder is preferably arranged outside the enclosure, but in particular inside the safety fence.

The enclosure is preferably at least partially at a distance from the ground and/or, in particular, not sealed.

This allows an air flow in the region of the floor, i.e., overall, in a lower region of the extrusion blow molding machine, which is directed from inside the enclosure towards the environment. This arrangement carries dirt particles away from the blow molding tool and out of the enclosure.

In this case, the floor is a region or level on which the blow molding machine is set up.

The volume enclosed by the enclosure is preferably less than 10 m³. This maximum value makes it possible to keep the effort required to introduce air and to create an overpressure within the enclosure within economical bounds.

Preferably, each compressor has a delivery rate of 1,200 m³ or less, preferably a delivery rate of 900 m³ or less. This also has a positive influence on the economic efficiency of the blow molding machine.

The invention will be explained with reference to schematic figures. In the figures:

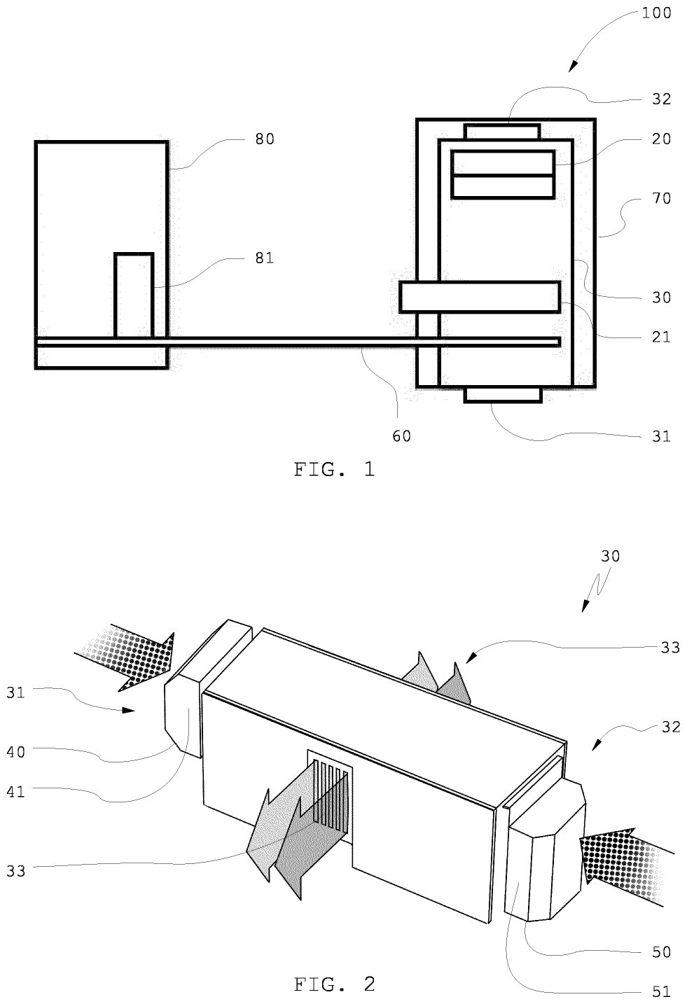

FIG. 1 shows a schematic view of a production system with an extrusion blow molding machine;

FIG. 2 shows an enclosure.

FIG. 1 shows a schematic view of a production system with an extrusion blow molding machine 100. The production system also includes a clean room 80 which is connected to the extrusion blow molding machine 100 via a conveyor belt 60. The extrusion blow molding machine 100 has a safety fence 70 within which an enclosure 30 is arranged. A blow molding tool 20 is arranged inside the enclosure 30. An extruder is arranged outside the enclosure 30, but within the safety fence 70. A discharge conveyor belt 21 extends from within the enclosure 30 to the outside, to remove sections from production from the material flow. The enclosure 30 has a first end 31 and a second end 32. The enclosure 30 also extends along the conveyor belt 60 and encloses this conveyor belt 60. The conveyor belt 60 ends in the clean room 80 in which the articles produced with the extrusion blow molding machine 100 are further processed—in this case with a packaging device 81.

FIG. 2 shows an enclosure 30. The enclosure 30 has a longitudinal extension which is delimited by a first end 31 and a second end 32. At the first end 31, i.e., at the front, a compressor 40 is arranged which is equipped with a filter element 41. The filter element 41 in the present case is a HEPA filter. At the second end 32, opposite the first end 31, a compressor 50 is arranged which is equipped with a filter element 51. The filter element 51 in the present case is a HEPA filter. Between the first end 31 and the second end 32, side outlet openings 33 are arranged in the enclosure 30 through which the air conveyed by the compressors 40 and 50 can flow out. Appropriate diffusers in the outflow openings 33 ensure that an overpressure is formed within the enclosure 30.

The blow molding tool, not shown here, is arranged within the enclosure 30.

1. An extrusion blow molding machine (100) comprising an extruder and a blow molding tool (20), wherein the blow molding tool (20) is separated from the environment by an enclosure (30).

2. The extrusion blow molding machine (100) according to claim 1, wherein a compressor (40) is arranged on the enclosure (30) at a first front end (31) for supplying the enclosure (30) with air.

3. The extrusion blow molding machine (100) according to claim 2, wherein a compressor (50) is arranged on the enclosure (30) at a second end (32) opposite the first front end (31), for supplying the enclosure (30) with air.

4. The extrusion blow molding machine (100) according to claim 2, wherein outflow openings (33) are arranged on the side of the enclosure (30) so that a substantially horizontal flow is created.

5. The extrusion blow molding machine (100) according to claim 2, wherein each compressor (40, 50) is assigned a filter element (41, 51), in particular a HEPA filter.

6. The extrusion blow molding machine (100) according to claim 1, wherein a conveyor belt (60) is arranged within the enclosure (30) for conveying the blow-molded articles into a clean room (80).

7. The extrusion blow molding machine (100) according to claim 1, wherein the enclosure (30) is arranged within a safety fence (70).

8. The extrusion blow molding machine (100) according to claim 1, wherein the extruder is arranged outside the enclosure (30), in particular inside the safety fence (70).

9. The extrusion blow molding machine (100) according to claim 1, wherein the enclosure (30) is at least partially at a distance from the floor, in particular is not sealed.

10. The extrusion blow molding machine (100) according to claim 1, wherein a volume enclosed by the enclosure (30) is smaller than 10 m³.

11. The extrusion blow molding machine (100) according to claim 2, wherein each compressor (40, 50) has a delivery rate of 1,200 m³ or less, preferably a delivery rate of 900 m³ or less.
